(19) United States
(12) Patent Application Publication
(10) Pub. No.: US 2014/0255901 A1
(43) Pub. Date: Sep. 11, 2014

(54) Apparatus, System, and Method for Displaying Content

(71) Applicant: Fast Forward Academy, LLC, Altamonte Springs, FL (US)

(72) Inventors: Rain HUGHES, Orlando, FL (US); Matthew McBride, Altamonte Springs, FL (US); Ryan Mills, Winter Garden, FL (US); James Brashear, Oviedo, FL (US)

(73) Assignee: Fast Forward Academy, LLC, Altamonte Springs, FL (US)

(21) Appl. No.: 14/204,157

(22) Filed: Mar. 11, 2014

Related U.S. Application Data
(60) Provisional application No. 61/776,512, filed on Mar. 11, 2013.

(51) Int. Cl. G06F 17/24; G09B 5/08

(52) U.S. Cl. CPC G06F 17/241; G09B 5/08
USPC 434/362; 715/230

(57) ABSTRACT

An apparatus, system, and method for displaying content. A portion of content may be displayed to a user. Personal and community data relating to the portion of content may be displayed alongside the portion of content. The personal and community data may include performance-related data. Furthermore, portions of content may be selectively displayed based on customizable performance thresholds.

### CROSS-REFERENCE TO RELATED APPLICATIONS

This application claims priority to U.S. Provisional Application Ser. No. 61/776,512, filed Mar. 11, 2013 and entitled Apparatus, System, and Method for Displaying Content, the entire contents of which are hereby incorporated by reference.

### BACKGROUND

The advent of reading books, articles, and other word-based media on electronic devices has led to a surge of various devices and software applications designed to help users read. As physical books fall by the wayside in an electronic world, people are now using electronic readers for their own personal enjoyment, for business, and in education. Various pieces of software and hardware have been developed, nominally for these markets, to help make reading on electronics easier to do through various features such as better contrast, easier page turning, etc.

However, though these developments have made it easier for people to read text on electronics, they have not addressed all of the other associated activities with reading. Users who wish to highlight text on a standard reader to come back to later are usually out of luck. Taking notes requires a separate piece of software, a separate piece of hardware, or even sometimes a pencil and paper approach. Additionally, sharing notes, highlighting, bookmarks, and general comments related to either a whole piece or perhaps just a section of content is inefficient at best, usually requiring a user to go to a website, for example, to participate in a forum or use an email listserv.

There is a need for software which allows users to interact with written content on a real-time basis, allowing the user to annotate the text as necessary. Additionally, there is a need to be able to share such annotations with other users, and have the ability to coordinate discussions or assessments based on the content.

### SUMMARY

An apparatus, system, and method for displaying content. A portion of content may be displayed to a user. Personal and community data relating to the portion of content may be displayed alongside the portion of content. The personal and community data may include performance-related data. Furthermore, portions of content may be selectively displayed based on customizable performance thresholds.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a diagram of an exemplary computer system.

FIG. 2 shows an exemplary interface for adding a note.

FIG. 3 shows an exemplary bookshelf interface.

FIG. 4 shows an exemplary interface for bookmarking.

FIG. 5 shows an exemplary chapter index interface.

FIG. 6 shows an exemplary interface for changing font size.

FIG. 7 shows an exemplary custom table of contents interface.

FIG. 8 shows an exemplary interface for direct searching.

FIG. 9 shows an exemplary interface for displaying community data.

FIG. 10 shows an exemplary interface for highlighting notes.

FIG. 11 shows an exemplary interface for viewing notes.

FIG. 12 shows an exemplary note list interface.

FIG. 13 shows an exemplary search results interface.

FIG. 14 shows an exemplary search results interface with matched notes.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

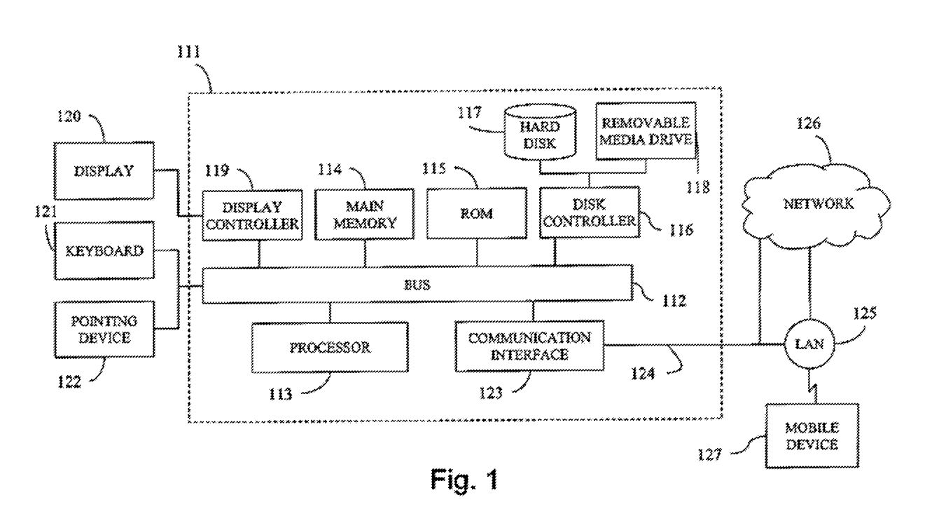

FIG. 1a illustrates a computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer client 204. The computer system includes input devices, such as a keyboard 121 and a pointing device 122, for interacting with a computer client 204 and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human client. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be a wireless link. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., an 802.11-compliant wireless network, or as desired) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

According to at least one exemplary embodiment, a system, method, and software product for displaying content, hereinafter referred to as the “Page Turner”, are disclosed. The Page Turner may provide advantageous content display for computer-based reading tools as well as computer-based education. The Page Turner may display content in one of at least two basic views: the “Regular” view and the “Custom” or “Enhanced” view. The Page Turner may also include features such as: the ability to highlight portions of the content, the ability to create, save and display notes relating to selected and/or highlighted portions of the content, the ability to view personal exam results as well as community exam results for a section of content, the ability to share notes between users of a system implementing the Page Turner, the ability to bookmark a section of content, the ability to search content as well as user-created notes, and the ability to view one's progress through a portion of content. The portion of content may be any desired grouping of content such as a chapter, a section, a book, and so forth, as well as an exam, quiz, problem set, group of questions, and the like.

The Page Turner may be implemented by any system that provides content. In some exemplary embodiments, the Page Turner may be implemented by a system for online education that includes community interactions. An example of such a system is taught in U.S. patent application Ser. No. 13/248,323, the entire disclosure of which is incorporated herein by reference.

In Regular view, the Page Turner can present an entire portion of content. The portion of content may further be subdivided into a plurality of subportions. For example, a book may be subdivided into a plurality of sections, a section may be subdivided into a plurality of chapters, a chapter may be subdivided into a plurality of topics, and so forth. The Regular view of the Page Turner may allow the user to view the entire portion of content by way of sequential page-by-page navigation, as well as view the subportions of the portion of content by way of a table of contents. In some exemplary embodiments, the table of contents may provide direct navigation to a subportion of content through linking or hyperlinking.

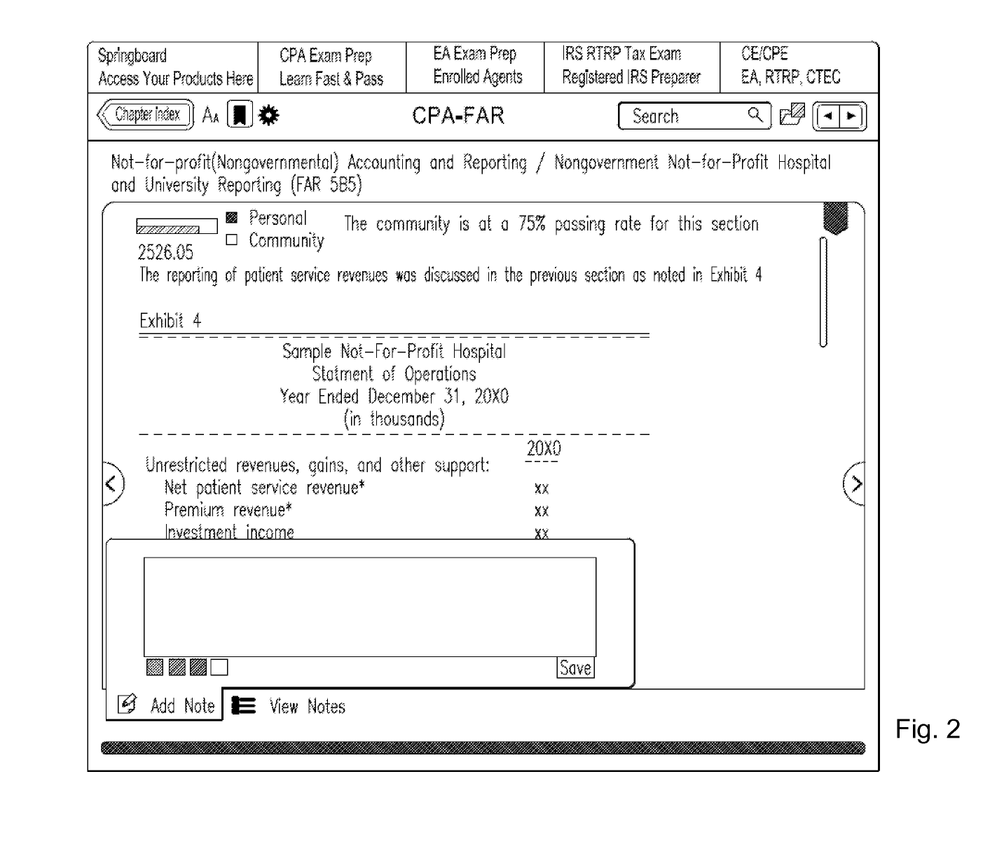

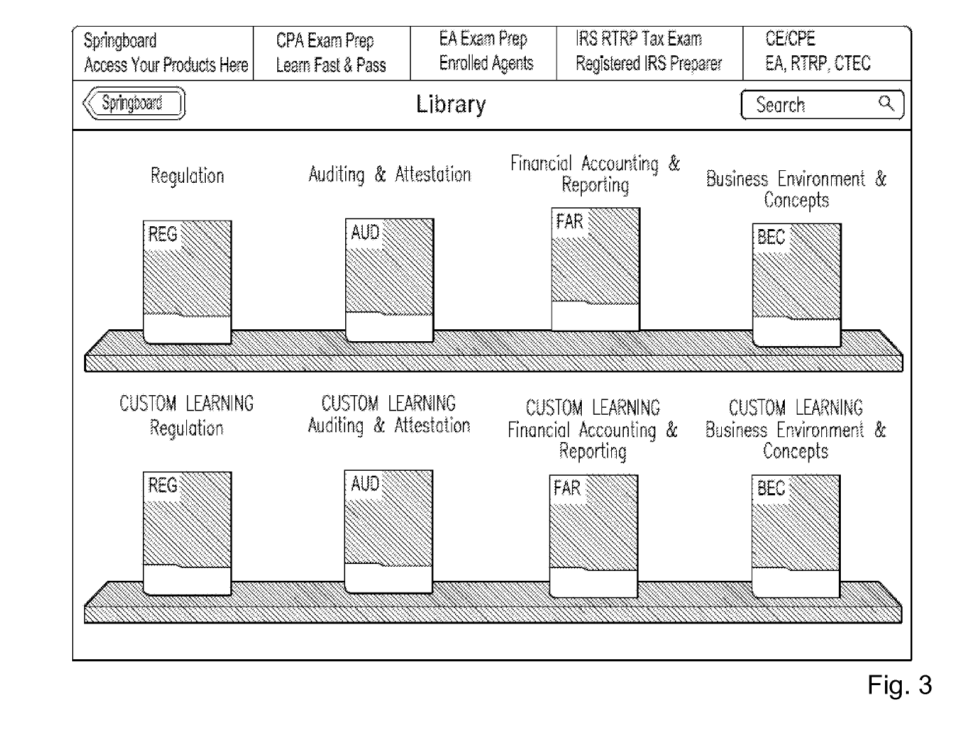

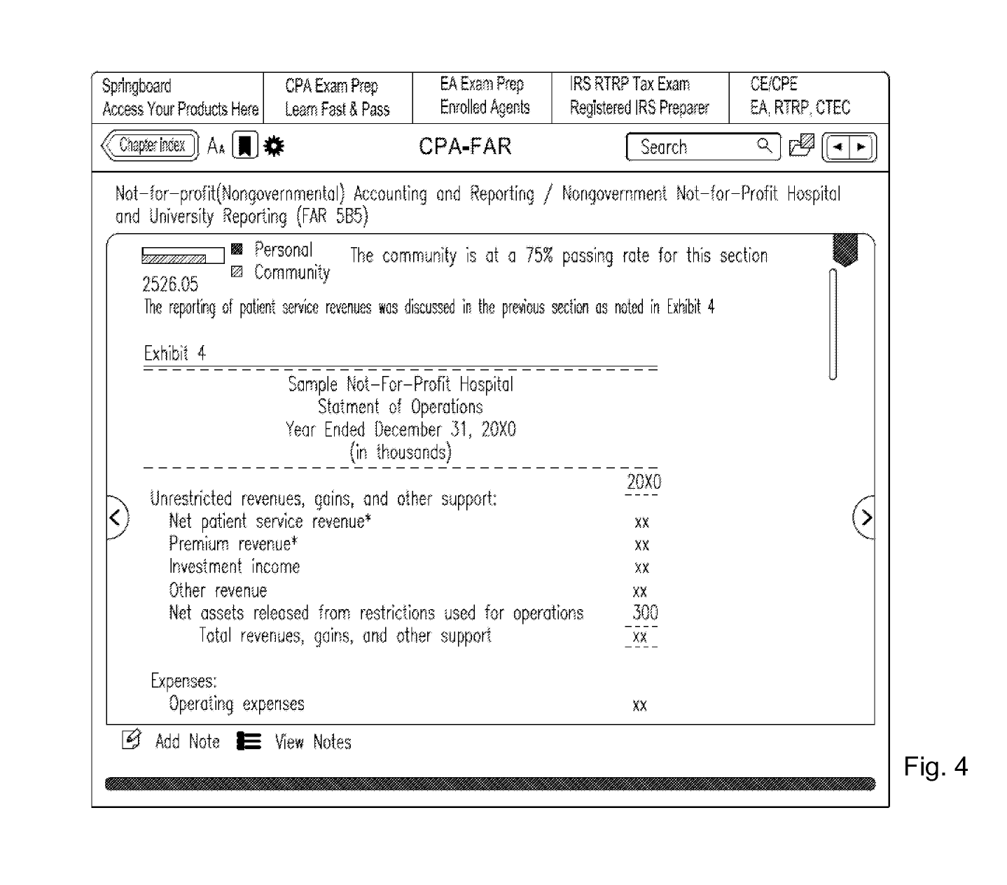

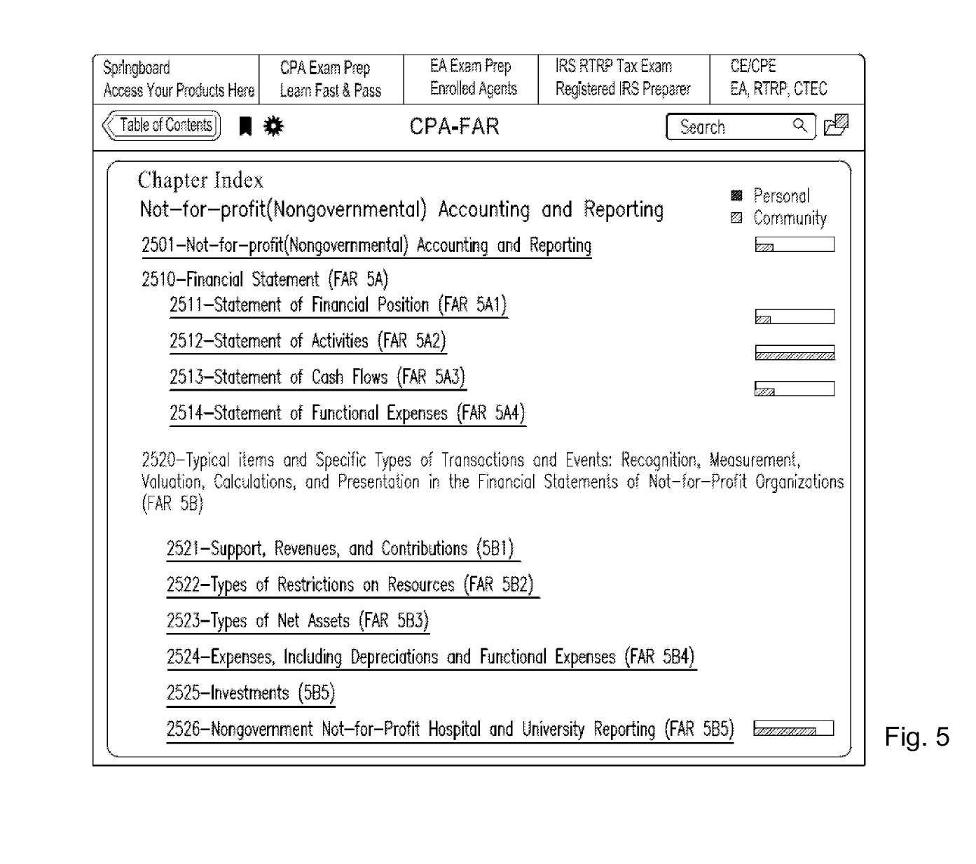

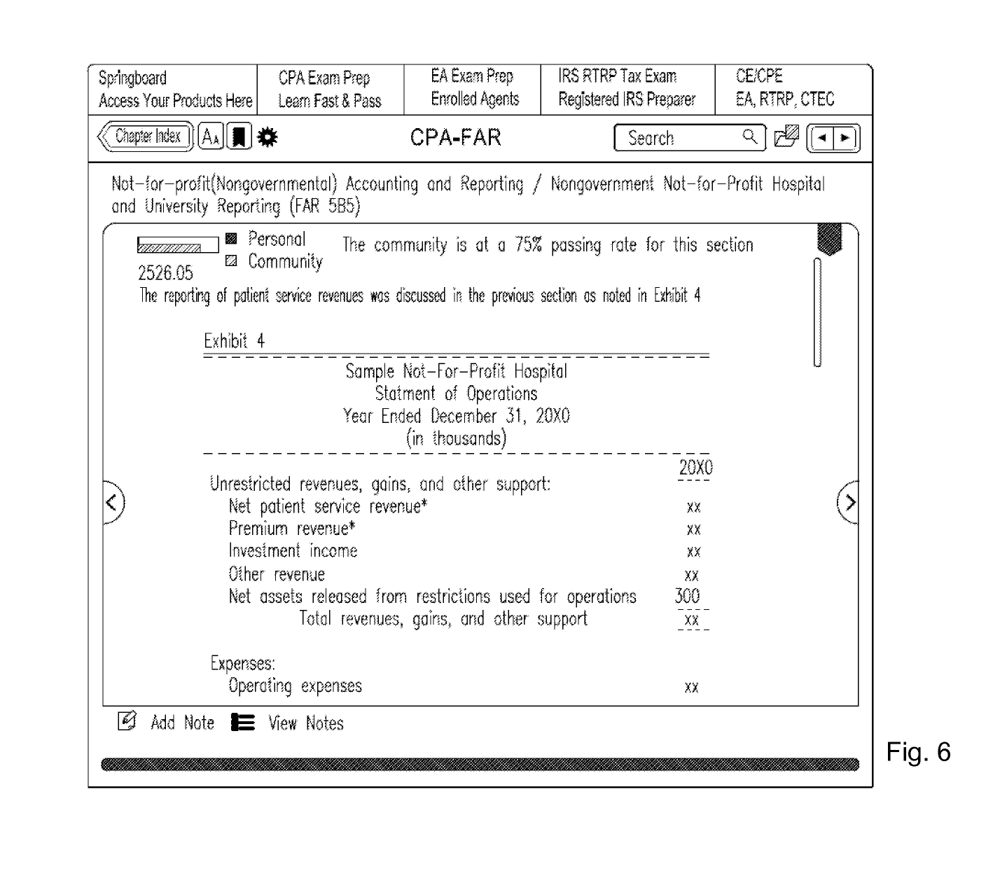

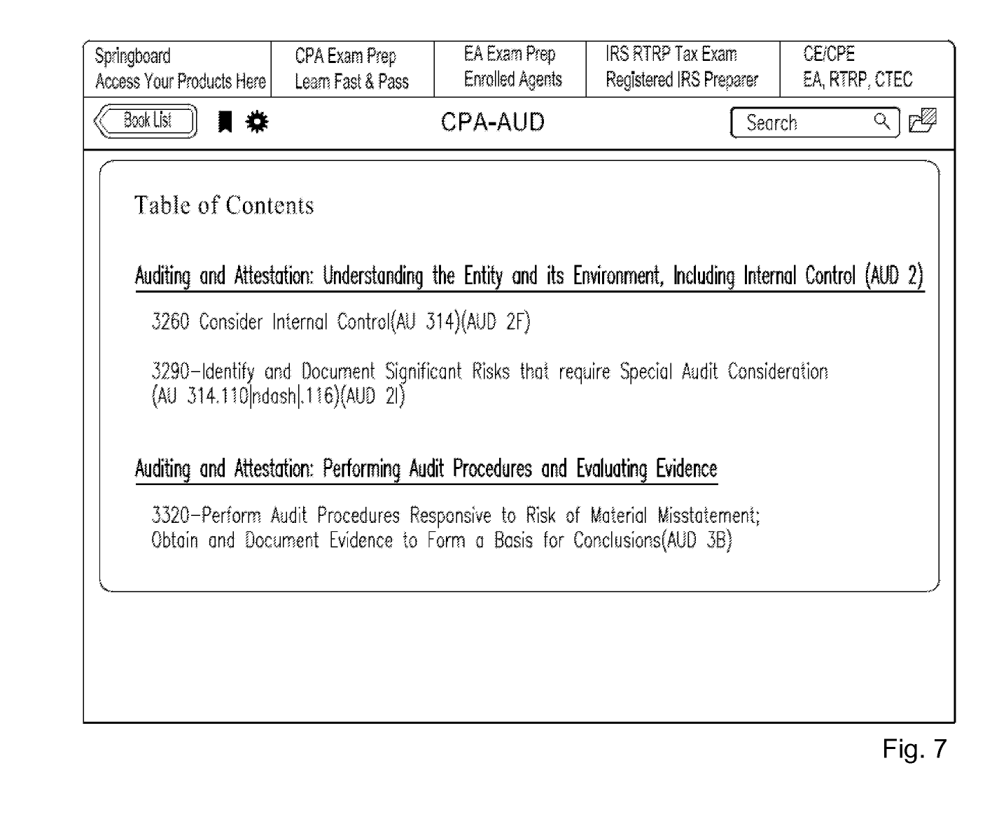

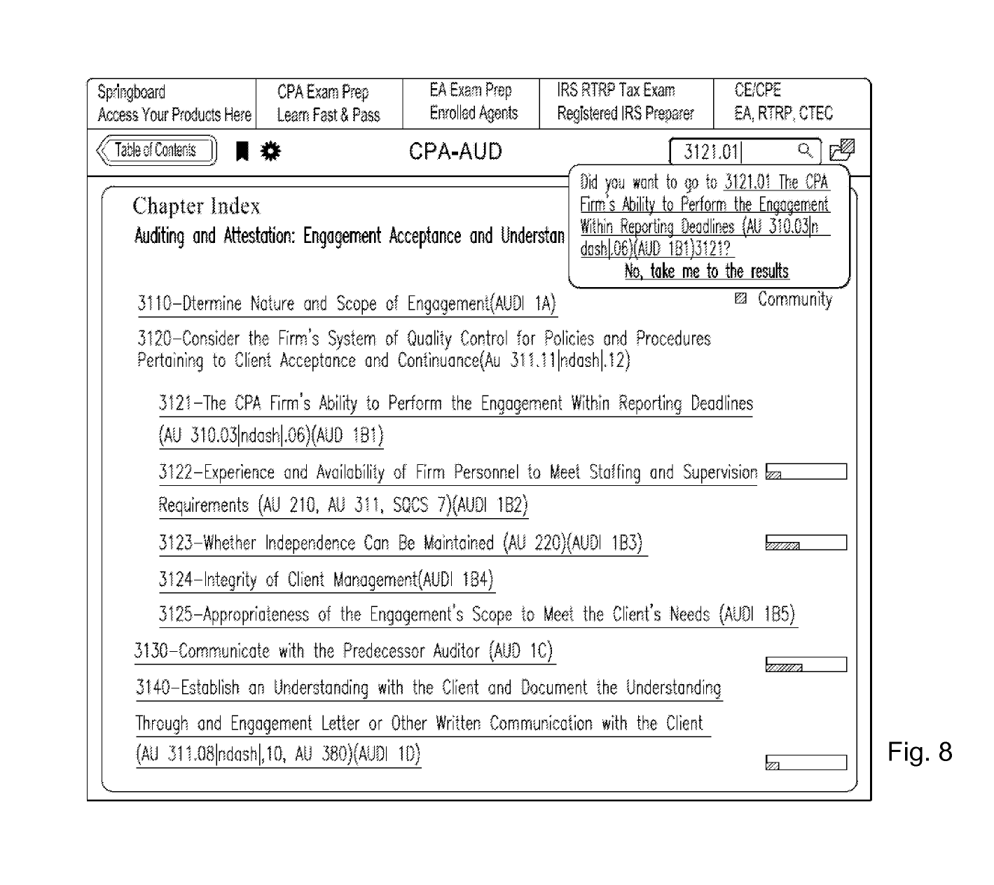

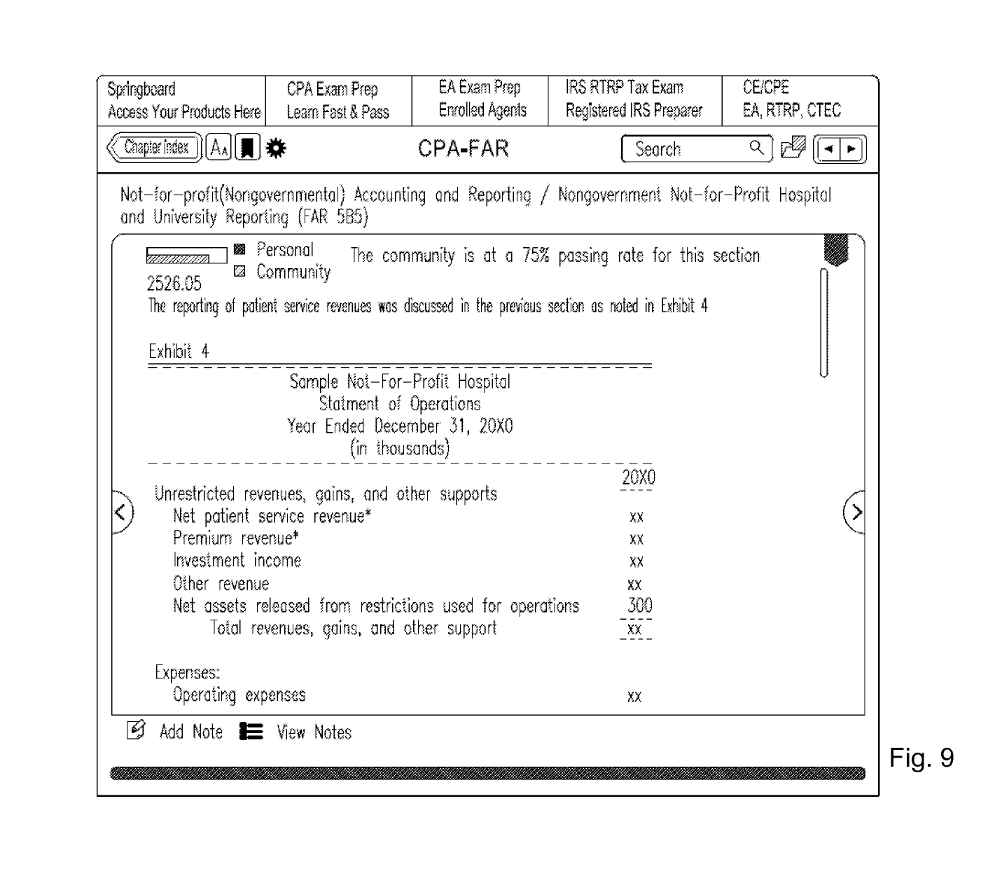

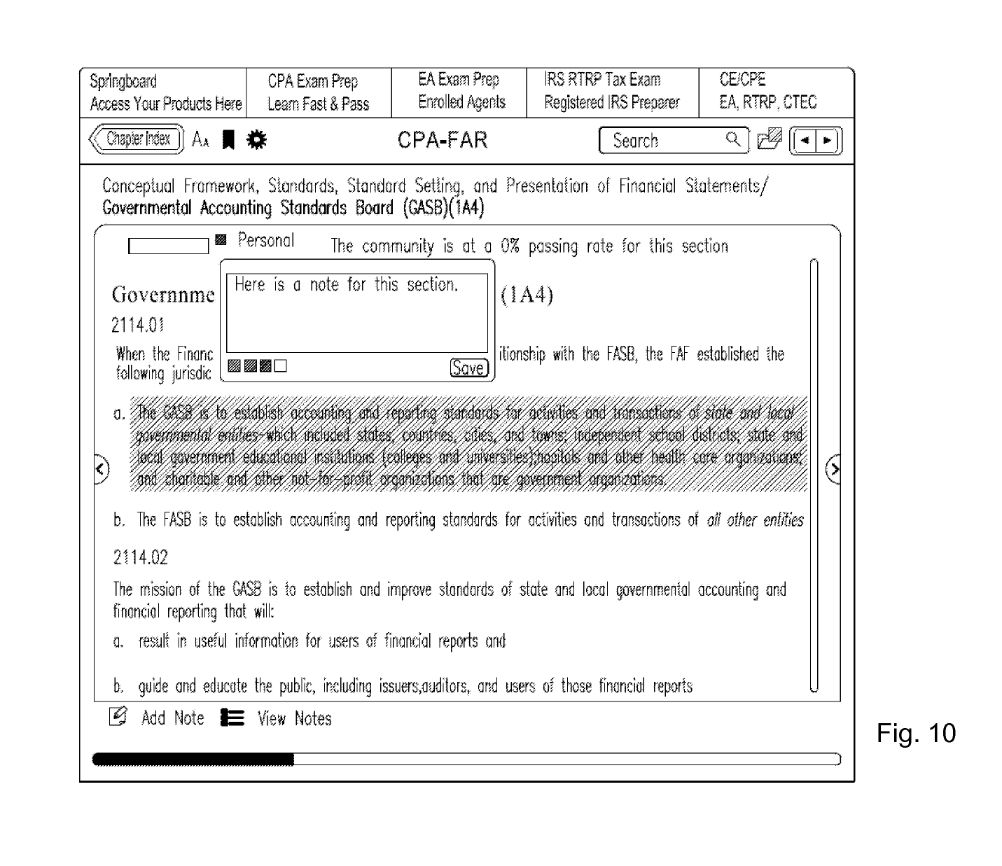

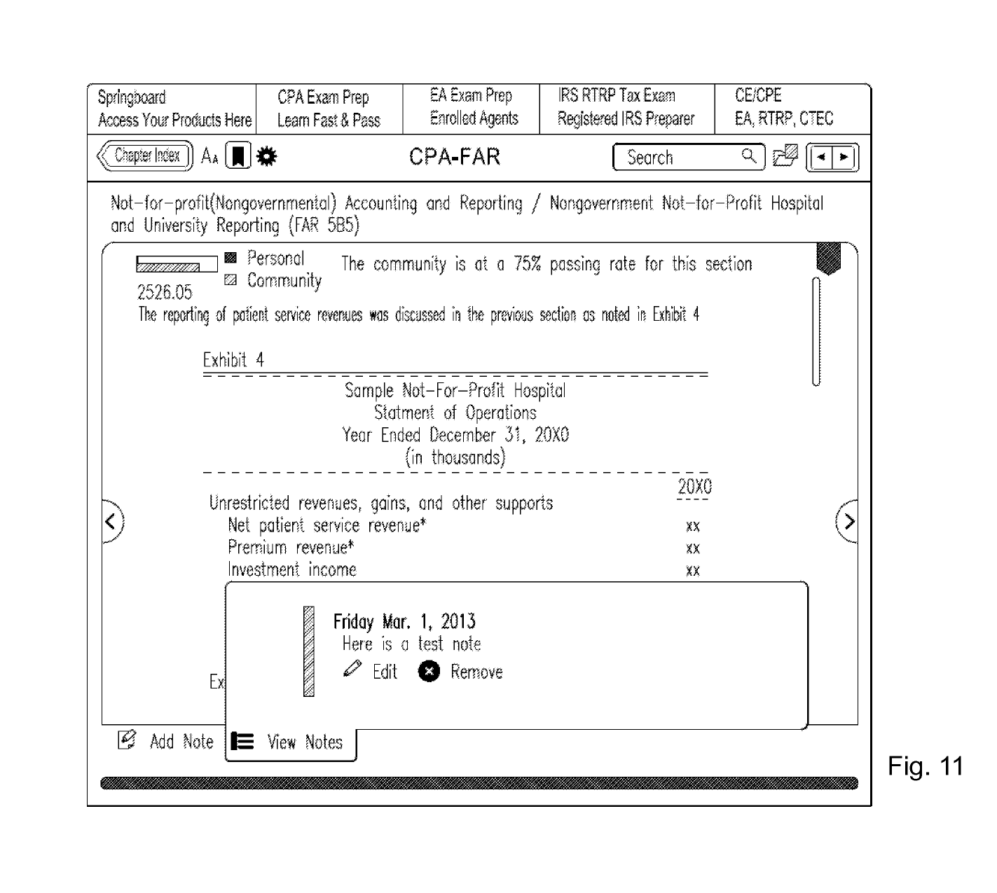

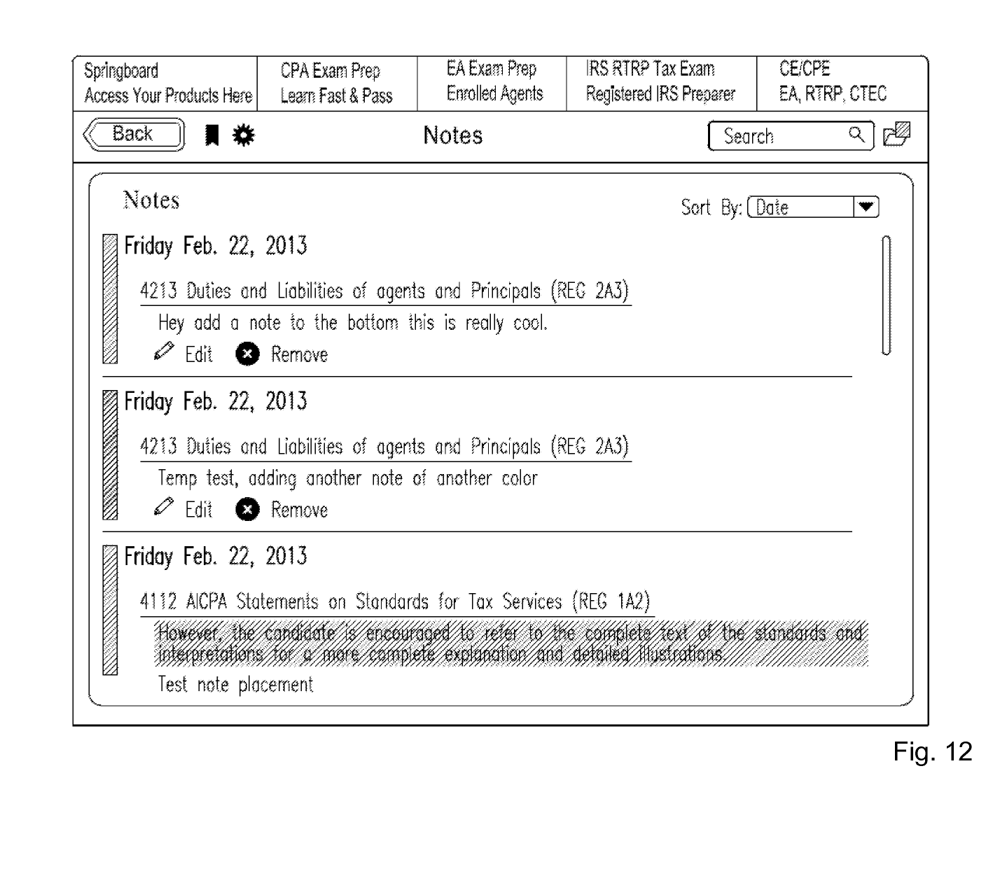

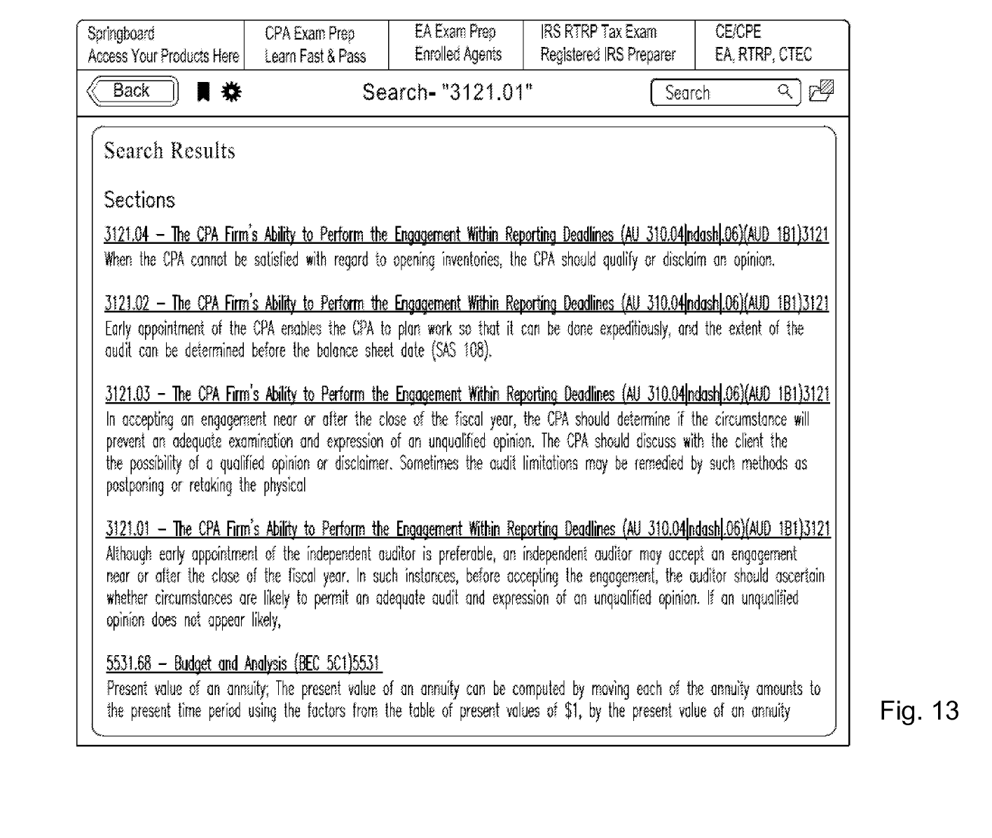

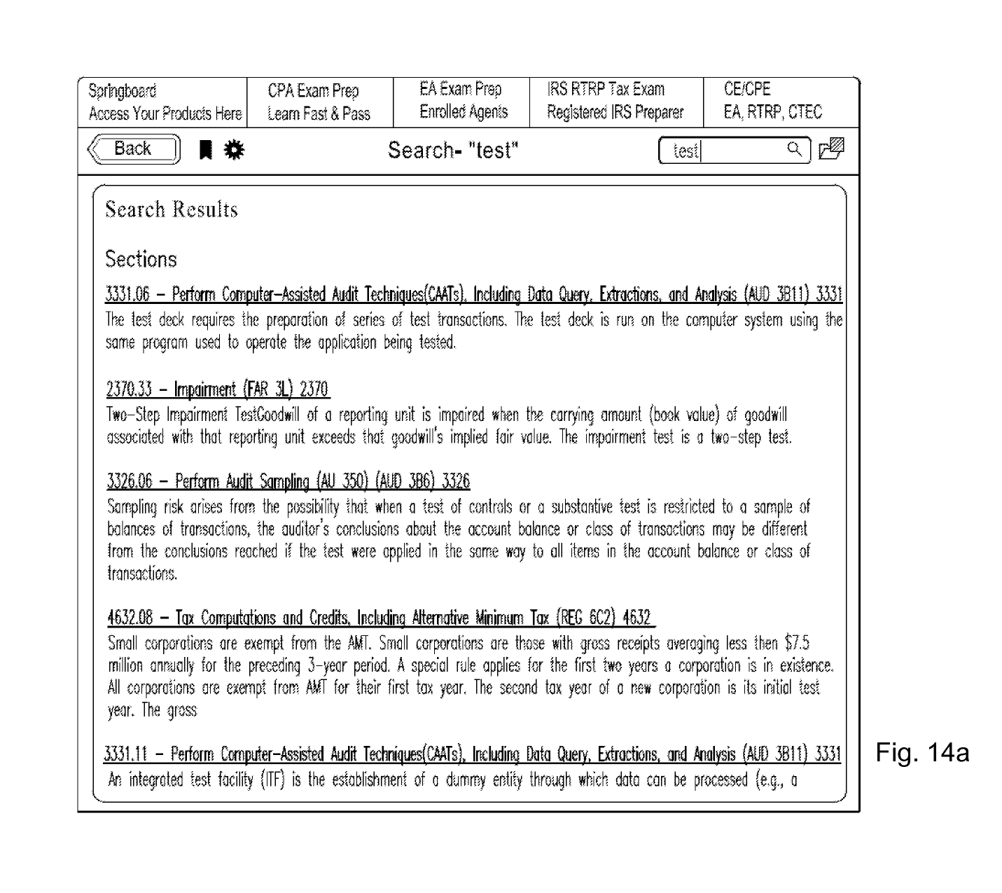

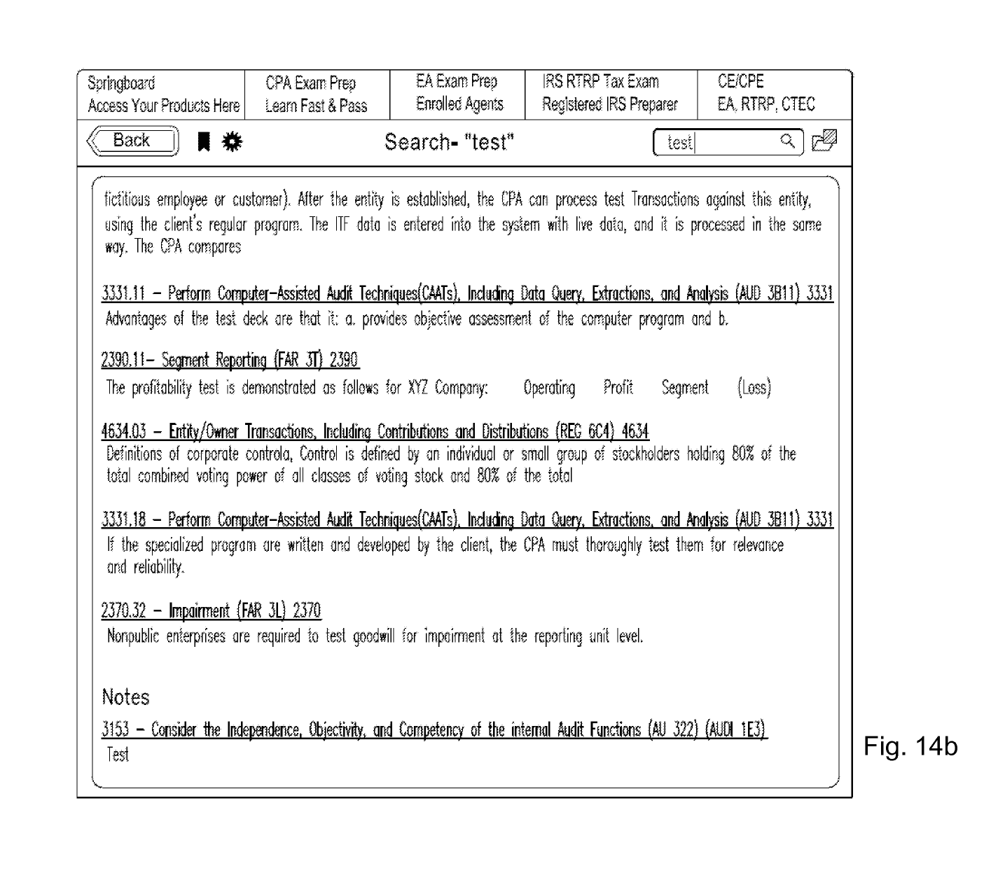

Referring to FIGS. 2, 4-6, and 9-11, the exemplary Regular view may allow a user to view community data as well as personal data that relates to the portion of content that the user is viewing. Personal data may be data that has been created or generated by the user and may include, for example, notes, flashcards, bookmarks, performance results on quizzes or exams relating to the content, flashcards, supplemental media, and so forth. Community data may be data that has been created or generated by the community of users utilizing a system implementing the Page Turner, for example a community of users registered with an online education system. In some embodiments, community data may include direct data, analysis, or statistical information derived from the personal data of members of a community. Community data may include, for example, notes, performance results on quizzes or exams relating to the content, flashcards, bookmarks, supplemental media, and so forth. Furthermore, the personal data may be displayed alongside, and/or compared to the community data. For example, the Page Turner may show a user's performance 120 on a particular portion of content as well as the community's performance 122 on that particular portion of content. Performance may be measured in any desired manner, for example, the amount of questions that have been correctly answered, the amount of time spent viewing/working on a portion of content, the average amount of time spent per question, and so forth.

The features provided in the Custom or Enhanced view of the Page Turner may be similar to the features of the Regular view, described above. However, the Custom view may not include methodology guidelines for answering any questions, and solving any problems, exams or quizzes that may be provided as part of the content. Furthermore, the Custom view may allow the user to selectively display portions of content. For example, the Custom view may be configured to selectively display only the portions of content in which the user has not exceeded a desired threshold of performance. As a further example, the user may set a threshold at any desired performance value, for example, an 80% correct answer rate. The Custom view may then display only those portions of content in which the user has answered less than 80% of the questions correctly. The Custom view may be customized for any desired performance threshold as well as any desired performance metric. The Custom view may thus allow the user to practice those sections of content in which the user has a demonstrated weakness. Customization may also be based on any additional desired user preferences, for example, desired content portions, desired content topics, desired content difficulty, and so forth. An exemplary embodiment of the Custom view may be used to perform quizzes, exams, or further practice in desired portions or subportions of content.

In further exemplary embodiments, the Page Turner may include additional features to facilitate viewing content, sharing content, as well as taking exams, answering questions, and so forth. The Page Turner may include the ability to highlight specific content and to create and store a note that is associated with the specific content. The Page Turner may further include the ability to create and store a general note that is associated with an entire section of content. The note may be saved for future viewing, including in subsequent sessions of using the Page Turner. The note may be specific to the user who created it. Alternatively, in some embodiments, users may be able to post a note that is available to a community of users. The ability of a user to post a note available to a community may be limited to select users.

The Page Turner may further include the ability to create custom flashcards from a combination of user generated content and predefined content.

The Page Turner can further include the ability to organize and view highlight notes, general notes, and flashcards.

The Page Turner can further include the ability to share notes and flashcards with other users of the community.

The Page Turner can further include the ability to bookmark any desired portion of content and to return thereto at any desired time.

The Page Turner can further include the ability search notes or portions of content, as well as the ability to auto-navigate to a portion of content if matching identifier for the portion of content, such as a section number, is found.

The Page Turner may further include the ability to track user progress, allowing the user to identify their progression through content provided through the Page Turner. In some exemplary embodiments, a teacher/instructor/employer may have the ability to review usage and performance data. The usage and performance data may be linked to a specific user or may be general usage and performance data. Teachers/instructors/employers may also have access to review user notes, user book customization, and user engagement. The Page Turner may provide for a user to ask a community of users or facilitators questions relating to a portion of content or to request comments relating to the portion of content. The question or request may be visible to all users in a given community and a response field may be provided to those users. The community of users may include other users registered with an online education system. The Page Turner may further include the ability to identify, select, index, and distribute custom content based on a variety of factors. Such factors may include individual preferences as well as the aggregate performance of a population on a specified portion of content. The Page Turner may further include the ability to group users based on a portion of content and/or on performance metrics. The Page Turner may further facilitate live communication via chat, video, etc. with other users of the content, for example within a group of users. The Page Turner may further include the ability to establish relationships between portions of content and to enhance the portions of content with supplemental media.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1-19. (canceled)

20. A computer-implemented method for displaying content, comprising:
registering a plurality of users;
providing access to and displaying content in a database to at least one of the plurality of users;
providing access to and displaying assessment material to at least one of the plurality of users;
allowing at least one of the plurality of users to interact with, respond to, and annotate the content and assessment material;
providing performance information associated with user interaction, responses, and annotation to the content and assessment material to at least one of the plurality of users; and
providing access to and displaying a comparison of an individual user's performance information with a plurality of users' performance information to at least the individual user.

21. The method of claim 20, further comprising allowing a first user to generate annotation content in relation to the displayed content, wherein the annotation content relates to a discrete subsection of the content, and the annotation content is displayed visually concurrently with the display of the content.

22. The method of claim 21, further comprising allowing access by a second user to view the content and the annotation content generated by the first user.

23. The method of claim 21, wherein the annotation content includes at least one of highlights, notes, flashcards, bookmarks, performance results on assessment material, or supplemental media.

24. The method of claim 20, wherein the user can customize the providing of and display of content and assessment material based on user preferences and user performance information.

25. The method of claim 24, wherein the assessment material is associated with a particular portion or sub-portion of content.

26. The method of claim 25, wherein the customization of content and assessment material occurs coextensively for content and assessment material that are associated, provided the associated content and assessment material lack association with other content or assessment material.

27. The method of claim 25, wherein the customization of the display of assessment material and associated content is automated based on performance information.

28. The method of claim 20, further comprising facilitating interactions among the plurality of users.

29. The method of claim 20, further comprising receiving a request by a user to navigate directly to a particular subsection within the piece of content.

30. A computer-implemented system for displaying content, comprising:
a database;
a plurality of user accounts;
a plurality of pieces of content; and
at least one added content;
wherein each of the plurality of user accounts further comprises an access control, said access control configured to define the user account's ability to access each of the pieces of content and added content,
wherein each of the added content further comprises a tag relating it to a subsection of a particular piece of content, and
wherein at least one user account is configured to allow the creation of new added content relating to a subsection of a particular piece of content, wherein the new added content is accessible by at least one other user account.

31. The system of claim 30, wherein the system is further operable to allow a user to customize the display of content and added content based on user preferences and performance data.

32. The system of claim 30, wherein the system is further operable to facilitate interactions between the users within a community.

33. The system of claim 30, wherein the system is further operable to allow a user to navigate directly to a particular subsection within the piece of content.

34. The system of claim 30, wherein the piece of content is a digital book.

35. The system of claim 30, wherein the system is accessible by the plurality of users through a web-based interface.

36. The system of claim 30, wherein the added content comprises at least one of a bookmark tag, highlighting, notes, community performance data, or individual performance data.

37. The system of claim 30, wherein the system is further operable to allow a user to search for text within a specified piece of content or a specified added content.

38. The system of claim 30, wherein the system is further operable to allow a user to create flashcards based on a piece of content.
